(19) United States
(12) Patent Application Publication
(10) Pub. No.: US 2007/0082683 A1
(43) Pub. Date: Apr. 12, 2007

(54) Call service providing system, method thereof, and mobile terminal paging method

(75) Inventors: Jee-Hyeon Na, Daejeon-city (KR); Sang-Ho Lee, Daejeon-city (KR); Jee-Hwan Ahn, Daejeon-city (KR); Yun-Won Chung, Daejeon-city (KR)

Correspondence Address: THE FARRELL LAW FIRM, 333 EARLE OVINGTON BOULEVARD., SUITE 701, UNIONDALE, NY, 11553, US

(73) Assignees: SAMSUNG ELECTRONICS CO., LTD., Suwon-si (KR); ELECTRONICS AND TELECOMMUNICATIONS RESEARCH INSTITUTE, Daejeon (KR); KT CORPORATION, Kyeonggi-do (KR); SK TELECOM CO., LTD., Seoul (KR); HANARO TELECOM., INC., Seoul (KR)

(21) Appl. No.: 11/546,792

(22) Filed: Oct. 12, 2006

(30) Foreign Application Priority Data
Oct. 12, 2005 (KR) 10-2005-0095993
Sep. 21, 2006 (KR) 10-2006-0091593

(51) Int. Cl. H04Q 7/20

(52) U.S. Cl. 455/456.1

(57) ABSTRACT

The present invention discloses a system for providing a call service for a mobile terminal to an application server. The system includes a location server that manages a location of the mobile terminal in an idle state by a paging group identifier. A paging controller detects a state and a location of the mobile terminal from the location server. When the mobile terminal is in the idle state, the paging controller requests a paging operation from at least one paging controller corresponding to the paging group having the mobile terminal so that the mobile terminal receives a network address when in the idle state, and provides the network address to the application server.

This application claims priority under 35 U.S.C. §119 to Korean Patent Application Nos. 10-2005-0095993 filed in the Korean Intellectual Property Office on Oct. 12, 2005, and 10-2006-0091593 filed in the Korean Intellectual Property Office on Sep. 21, 2006, the contents of which are incorporated herein by reference.

### BACKGROUND OF THE INVENTION

1. Field of the Invention

The present invention relates generally to a system and method for paging a mobile terminal, and more particularly to a paging and location management method for supporting a call service in an IEEE 802.16(e)-based wireless broadband system.

2. Description of the Related Art

An IEEE 802.16(e)-based wireless broadband system supports an idle mode to save power consumption of the terminal. To provide a call service to a mobile terminal in the idle mode, it is required to define a network configuration for managing a location of the idle mode terminal and control a paging process. In the IEEE 802.16(e) standard, a paging controller and a location manager are defined, but messages between the paging controller and the location manager are not defined.

In addition, since the IEEE 802.16(e)-based wireless broadband system may recover an Internet Protocol (IP) address corresponding to a network address used for routing from the idle mode terminal, it is difficult to support the call service for the idle mode terminal by a conventional paging method.

Accordingly, there is a need for an improved paging method for supporting the call service for the idle mode terminal.

### SUMMARY OF THE INVENTION

The present invention has been made in an effort to provide a network configuration for supporting a call service, a location management method and a paging method.

In a call service providing method according to the present invention, a paging controller cooperates with a location server and a base station to provide a call service for a mobile terminal to an application layer. The paging controller receives a request for the call service for the mobile terminal from the application server, and detects state and location information of the mobile terminal from the location server. In addition, the paging controller transmits a paging request message to the base station controller so that the mobile terminal interfaces with a network and receives a network address when the mobile terminal is in an idle state. The paging controller receives a paging response message having the network address from the base station controller to which the mobile terminal is accessed. The paging controller transmits a call service response message having the network address to the application server.

The paging controller receives a call service request message having an identifier of the mobile terminal from the application server to receive a request for the call service. In addition, the paging controller detects the state and location information of the mobile terminal from the location server through a physical address of the mobile terminal, and by the identifier of the mobile terminal.

In a mobile terminal paging method according to the present invention, the base station controller cooperates with a base station, a paging controller and a location server to page a mobile terminal. The base station controller receives a paging request message having a physical address of the mobile terminal and an identifier of a paging group having the mobile terminal, from the paging controller. In addition, the base station controller transmits a paging notify message having the physical address of the mobile terminal to at least one of base stations corresponding to the identifier of the paging group so that the at least one of base stations transmits a paging message having the physical address of the mobile terminal to a channel link. The base station controller provides a network address to the mobile terminal when the mobile terminal interfaces with a network, and registers a location of the mobile terminal to the location server by network address and a location registration message having an identifier of an access point to which the mobile terminal is accessed. In addition, the base station controller transmits a paging response message containing the physical address of the mobile terminal and the network address to the paging controller.

In a system for providing a call service for a mobile terminal to an application server according to the present invention, a location server manages a location of the mobile terminal in an idle state by an identifier of a paging group, and a paging controller detects a state and location of the mobile terminal from the location server when receiving the call service for the mobile terminal from the application server, requests a paging operation from at least one paging controller corresponding to the paging group having the mobile terminal so that the mobile terminal receives a network address when in the idle state, and provides the network address to the application server.

### BRIEF DESCRIPTION OF THE DRAWINGS

The above and other objects, features and advantages of the present invention will become more apparent from the following detailed description when taken in conjunction with the accompanying drawings in which:

FIG. 1 shows a diagram of a configuration of a wireless broadband network for providing a call service according to the present invention.

FIG. 2 shows a diagram representing operational states of a mobile terminal according to the present invention.

FIG. 3 shows a flowchart representing a location management method of the mobile terminal according to the present invention.

FIG. 4 shows a diagram representing a location registration request message according to the present invention.

FIG. 5 shows a diagram representing a location registration response message according to the present invention.

FIG. 6 shows a diagram representing the states of the mobile terminal and the location management method of the mobile terminal according to the present invention.

FIG. 7 shows a flowchart representing a method for providing a call service according to the present invention.

FIG. 8 shows a flowchart representing a Voice over Internet Protocol (VoIP) service method according to the present invention.

### DETAILED DESCRIPTION OF THE PREFERRED EMBODIMENTS

In the following detailed description, preferred embodiments of the present invention will be shown and described by way of illustration. As those skilled in the art would realize, the described embodiments may be modified in various manners without departing from the spirit or scope of the present invention. Accordingly, the drawings and description are to be regarded as illustrative in nature and not restrictive. Like reference numerals designate like elements throughout the specification. In the following description, well-known functions or constructions are not described in detail for the sake of clarity and conciseness.

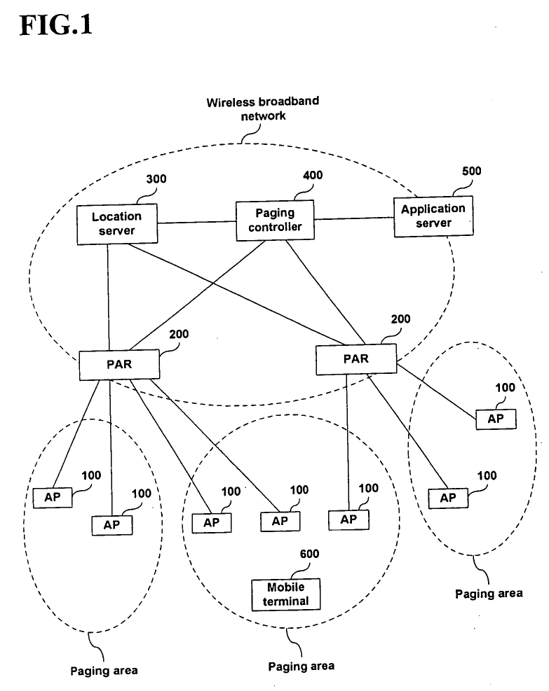

FIG. 1 shows a diagram of a wireless broadband network for providing a call service according to the present invention.

As shown in FIG. 1, the wireless broadband network includes a plurality of Access Points (AP) 100, a plurality of Packet Access Routers (PAR) 200, a Location Server (LS) 300, and a Paging Controller (PC) 400, and provides a call service to an application server 500 and a mobile terminal 600.

Each AP 100 corresponds to a base station, and wireless communication with the mobile terminal 600 is performed through a radio channel. The APs 100 are grouped to form one paging group, which manages a spatial area that will be referred to herein as a paging area.

Each PAR 200 corresponds to a base station controller, controls a plurality of APs 100, and interfaces with the location server 300 and the paging controller 400.

The location server 300 manages location information of the mobile terminal 600 by a Media Access Control (MAC) address corresponding to a physical address of the mobile terminal 600 or Network Access Identifier (NAI) including terminal MAC address information.

The paging controller 400 manages the paging area, and interfaces with each PAR 200 and the location server 300 to provide the call service to the application server 500.

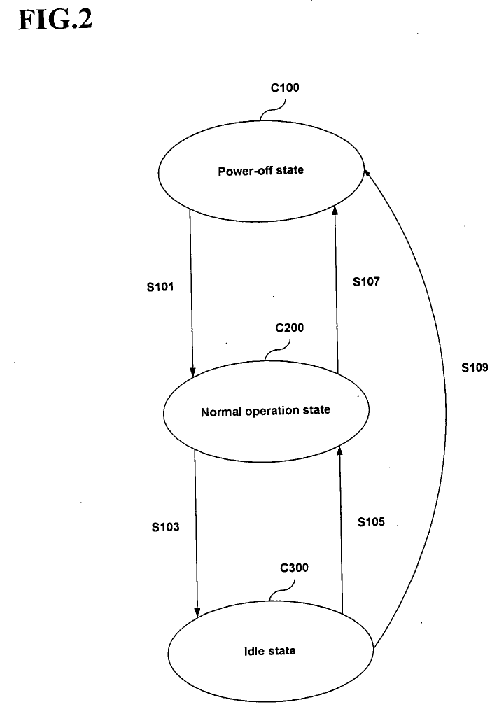

FIG. 2 shows a diagram representing operational states of the mobile terminal 600 according to the present invention.

As shown in FIG. 2, the operational states of the mobile terminal 600 include a power-off state C100, a normal operation state C200 and an idle state C300.

When power is supplied to the mobile terminal 600 in the power-off state C100 and the mobile terminal 600 interfaces with the wireless broadband network, the state of the mobile terminal 600 is changed to the normal operation state C200 in step S101. The mobile terminal 600 in the normal operation state C200 receives radio resources to transmit and receive data, and registers a location when handoff is performed.

Subsequently, the mobile terminal 600 in the normal operation state C200 moves to the idle state C300 in step S103 when data is not transmitted or received for a predetermined time. The mobile terminal 600 in the idle state C300 returns resources for transmitting a packet, and manages the power to receive paging information and minimize power consumption.

When data to be transmitted is generated at an AP 100 or the paging information is received, the mobile terminal 600 in the idle state C300 interfaces with the wireless broadband network to enter the normal operation state C200 in step S105.

When the power is cut off, the mobile terminal 600 in the normal operation state C200 moves to the power-off state C100 in step S107.

In addition, when data is not transmitted or received for a predetermined time, the mobile terminal 600 in the idle state C300 moves to the power-off state C100 in step S109.

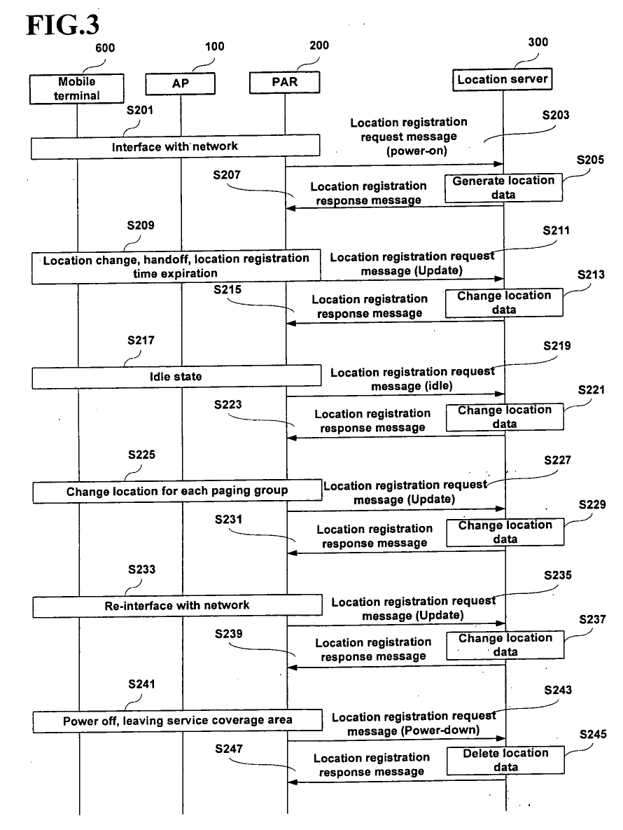

A method for managing a location of the mobile terminal 600 according to the state of the mobile terminal in the wireless broadband network of the present invention will now be described with reference to FIG. 3 to FIG. 6.

FIG. 3 shows a flowchart representing a location management method of the mobile terminal 600 according to the present invention.

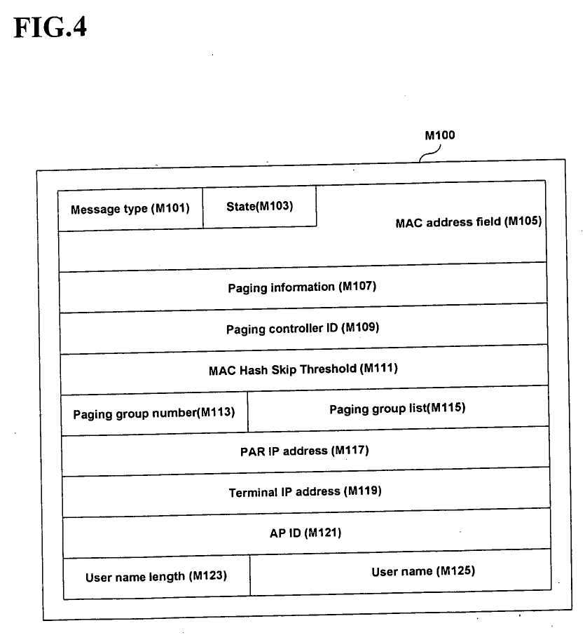

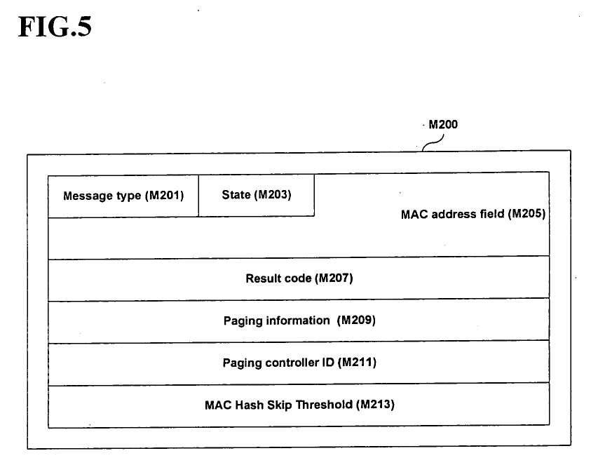

As shown in FIG. 3, when the state or the location of the mobile terminal 600 is changed, a PAR 200 transmits a location registration request message shown in FIG. 4 to the location server 300 to request location registration. The location server 300 registers the location, and transmits a location registration response message shown in FIG. 5 to the transmitting PAR 200.

FIG. 4 shows a diagram representing the location registration request message M100 according to the present invention.

As shown in FIG. 4, the location registration request message M100 includes a message type field M101, a state field M103, a Media Access Control (MAC) address field M105, a paging information field M107, a paging controller identifier (ID) field M109, a MAC Hash Skip Threshold field M111, a paging group number field M113, a paging group list field M115, a PAR Internet protocol (IP) address field M117, a terminal IP address field M119, an AP ID field M121, a user name length field M123 and a user name field M125.

The message type field M101 indicates that a message relates to a location registration request.

The state field M103 indicates a location registration request, and includes values of power-on, update, idle and power-down.

The MAC address field M105 includes a MAC address of the mobile terminal 600 relating to the location registration request message M100.

The paging information field M107 includes cycle information and offset information to perform paging by a MAC message between the mobile terminal 600 and the AP 100.

The paging controller ID field M109 includes an identifier for identifying the paging controller 400.

The MAC Hash Skip Threshold field M111 indicates the number of sequential MOB_PAG-ADV (BaseStation Broadcasting Paging Advertisement) messages transmitted by the access point 100 without an individual notice. The MOB_PAG-ADV message is a MAC message used when the access point 100 pages the mobile terminal 600.

The paging group number field M113 indicates the number of paging groups that include the access point 200 to which the mobile terminal 600 relating to the location registration request message M100 is accessed.

The paging group list field M115 includes a list of the paging groups corresponding to the paging group number field M113.

The PAR IP address field M117 includes an IP address of the PAR 200 for controlling the AP 100 to which the mobile terminal 600 relating to the location registration request message M100 is accessed.

The terminal IP address field M119 includes an IP address of the mobile terminal relating to the location registration request message M100.

The AP ID M121 includes an identifier (e.g., a 48 bit BS ID used in the IEEE 802.16(e) standard) of the AP 100 to which to which the mobile terminal 600 relating to the location registration request message M100 is accessed.

The user name length field M123 indicates a length of the user name field M125.

The user name field M125 and the Network Access Identifier (NAI) are used to perform user authentication for a wireless broadband Internet subscriber, and the location server 300 performs location management by a user name.

FIG. 5 shows a diagram representing the location registration response message M200 according to the present invention.

As shown in FIG. 5, the location registration response message M200 includes a message type field M201, a state field M203, a MAC address field M205, a result code field M207, a paging information field M209, a paging controller ID field M211 and a MAC Hash Skip Threshold field M213.

The message type field M201 indicates that the message relates to a location registration response.

The state field M203 and the MAC address field M205 store the same values as the state field M103 and the MAC address field M105 of the location registration request message M100.

The result code field M207 includes a result value for a location registration request.

To change the paging information, the paging controller identifier, or the MAC Hash Skip Threshold received by the location registration request message M100, the location server 300 provides the paging information field M209, the paging controller identifier field M211 or the MAC Hash Skip Threshold field M213 to the location registration response message M200 to transmit the location registration response message M200 to the PAR 200.

Referring back to FIG. 3, when the power is supplied to the mobile terminal 600 in the power-off state C100, and the mobile terminal 600 in the power-off state C100 interfaces with the wireless broadband network in step S201, the PAR 200 registers the location of the mobile terminal 600 to the location server 300 by the location registration request message M100 including the state field M103 of the power on value in step S203. In this case, the location registration request message M100 includes an address of the PAR 200 to which the mobile terminal 600 is accessed, the IP address of the mobile terminal 600, the identifier of the AP 100 to which the mobile terminal 600 is accessed, and an identifier of the paging group. Subsequently, the location server 300 generates location data for the mobile terminal 600 based on the received location registration request message M100 in step S205, and replies with a generation result of the location data by the location registration response message M200 in step S207.

When the location of the mobile terminal 600 in the normal operation state C200 is changed or the mobile terminal 600 in the normal operation state C200 performs the handoff in step S209, the packet access router 200 registers the location of the mobile terminal 600 to the location server 300 in step S211. In addition, when a location registration timer of the mobile terminal 600 in the normal operation state C200 expires in step S209, the PAR 200 registers the location of the mobile terminal 600 to the location server 300 in step S211. The PAR 200 registers the location of the mobile terminal 600 in the normal operation state C200 by the location registration request message M100 including the state field M103 of the update value. The location server 300 receiving the location registration request message M100 including the state field M103 of the update value changes the location data of the mobile terminal 600 in step S213, and replies with a location data change result by way of the location registration response message M200 in step S215.

When the mobile terminal 600 in the normal operation state C200 does not transmit or receive the data for a predetermined time, the PAR 200 changes the state of the mobile terminal 600 in the normal operation state C200 to the idle state C300 in step S217, and registers the location of the mobile terminal 600 by the location registration request message M100 including the state field M103 of the idle value in step S219. The location server 300 receiving the location registration request message M100 including the state field M103 of the idle value changes the location data of the mobile terminal 600, and manages the location of the mobile terminal 600 for each paging group in step S221. Subsequently, the location server 300 replies with the location data change result by way of the location registration response message M200 in step S223.

When the location of the mobile terminal 600 in the idle state C300 is changed for each paging group in step S225, the PAR 200 registers the location of the mobile terminal 600 to the location server 300 by the location registration request message M100 including the state field M103 of the update value in step S227. The location server 300 changes the location data of the mobile terminal 600 for each paging group in step S229, and replies with the location data change result by way of the location registration response message M200 in step S231.

When the mobile terminal 600 in the idle state C300 re-interfaces with the wireless broadband network and the state of the mobile terminal 600 is changed to the normal operation state C200 in step S233, the packet access router 200 registers the location of the mobile terminal 600 to the location server 300 by the location registration request message M100 including the state field M103 of the update value in step S235. The location server 300 changes the location data of the mobile terminal 600 in step S237, and replies with the location data change result by way of the location registration response message M200 in step S239.

When the access between the mobile terminal 600 in the normal operation state C200 or the idle state C300 and the wireless broadband network is canceled by the terminal power being turned off or leaving the service coverage area in step, S241, the PAR 200 changes the state of the mobile terminal 600 to the power-off state C100, and transmits the location registration request message M100 including the state field M103 of the power down value in step S243. The location server 300 deletes the location data of the mobile terminal 600 in step S245, and replies with a location data deletion result by way of the location registration response message M200 in step S247.

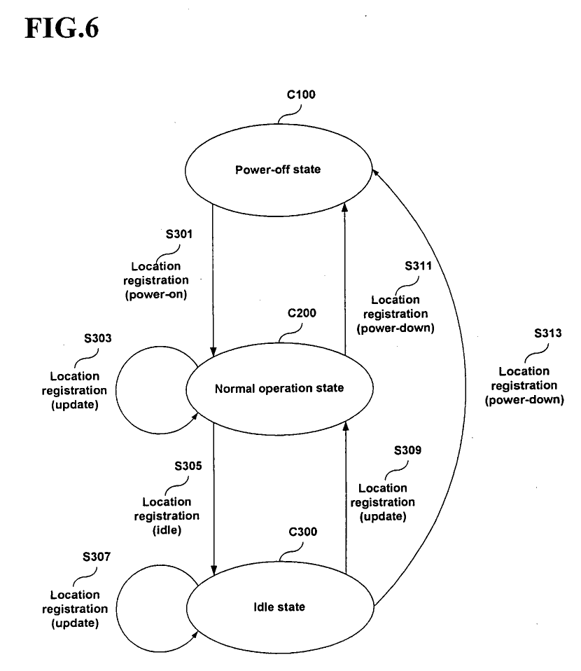

FIG. 6 shows a diagram representing the states of the mobile terminal 600 and the location management method of the mobile terminal 600 according to the present invention.

As shown in FIG. 6, when the state of the mobile terminal 600 is changed from the power-off state C100 to the normal operation state C200, the PAR 200 registers the location of the mobile terminal 600 to the location server 300 through the location registration request message M100 including the state field M103 of the power on value in step S301.

In addition, when the location of the mobile terminal 600 in the normal operation state C200 is changed by the handoff or a location registration timer is expired, the PAR 200 registers the location of the mobile terminal 600 to the location server 300 by the location registration request message M100 including the state field M103 of the update value in step S303.

When the state of the mobile terminal 600 is changed from the normal operation state C200 to the idle state C300, the PAR 200 registers the location of the mobile terminal 600 to the location server 300 by the location registration request message M100 including the state field M103 of the idle value in step S305.

When the location of the mobile terminal 600 in the idle state C300 is changed for each paging group, the PAR 200 registers the location of the mobile terminal 600 to the location server 300 by the location registration request message M100 including the state field M103 of the update value in step S307.

When the state of the mobile terminal 600 is changed from the idle state C300 to the normal operation state C200, the PAR 200 registers the location of the mobile terminal 600 to the location server 300 by the location registration request message M100 including the state field M103 of the update value in step S309.

In addition, when the state of the mobile terminal 600 is changed from the normal operation state C200 to the power-off state C100, the packet access router 200 transmits the location registration request message M100 of the state field M103 of the power down value so that the location server 300 deletes the location data of the mobile terminal 600 in step S311.

When the state of the mobile terminal is changed from the idle state C300 to the power-off state C100, the PAR 200 transmits the location registration request message M100 including the state field M103 of the power down value to the location server 300 so that the location server 300 deletes the location data of the mobile terminal 600 in step S313.

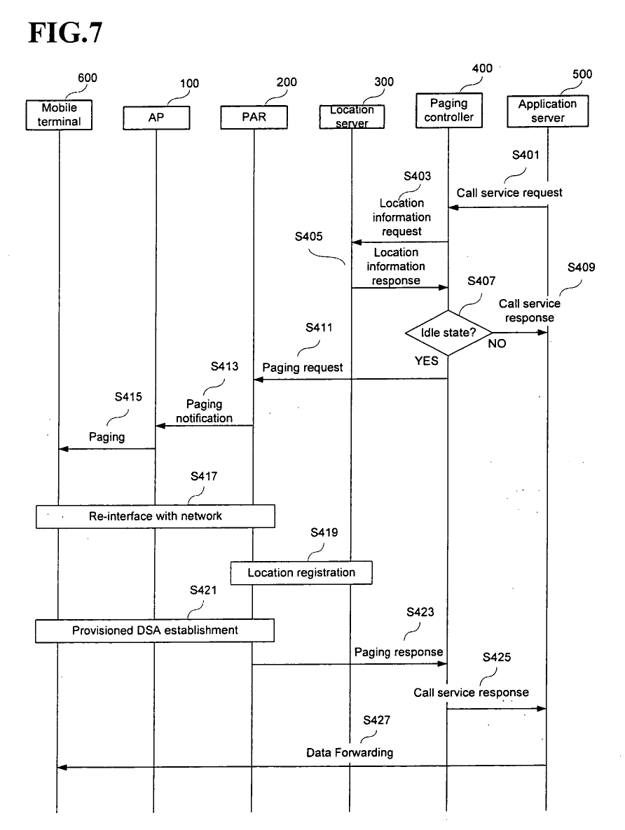

FIG. 7 shows a flowchart representing the method for providing the call service according to the present invention.

When there is data to be transmitted to the mobile terminal 600, the application server 500 requests the call service from the paging controller 400 by a call service request message in step S401. The call service request message includes an identifier of the mobile terminal 600 to which the call service is provided and service-type information. The identifier of the mobile terminal 600 in the call service request message may be a MAC address of the mobile terminal 600 or may be the NAI of the mobile terminal 600.

The paging controller 400 receiving the call service request message requests the location information from the location server 300 by a location information request message in step S403. Here, the location information request message includes the MAC address of the mobile terminal 600. When the identifier of the mobile terminal 600 in the call service request message is not the MAC address, the paging controller 400 detects the MAC address of the mobile terminal 600 from MAC address mapping information to generate the location information request message. When the location server 300 manages the location by the NAI, the paging controller 400 may determine the location of the mobile terminal 600 by the location information request message including the NAI.

The location server 300 receiving the location information request message transmits a location information response message to the paging controller 400 in response to the location information request message in step S405. In this case, the location information response message includes the MAC address of the mobile terminal 600, and the location and the state of the mobile terminal 600. When the mobile terminal 600 is in the power-off state C100, there is no need for location information of the mobile terminal 600. When the mobile terminal 600 is in the normal operation state C200, the location information of the mobile terminal 600 corresponds to the AP 100. For example, the information on the location of the mobile terminal 600 in the normal operation state C200 includes the IP address of the mobile terminal 600 and the identifier of the AP 100 to which the mobile terminal 600 is accessed, and may further include the IP address of the PAR 200 for controlling the AP 100. When the mobile terminal 600 is in the idle state C300, the location information of the mobile terminal 600 corresponds to the paging group. Accordingly, the location information of the mobile terminal in the idle state C300 includes the identifier of the paging group including the mobile terminal 600.

Subsequently, the paging controller 400 receiving the location information response message determines the state of the mobile terminal 600 in step S407. When the mobile terminal 600 is in the normal operation state C200 in step S407 (or is not in the idle state), the paging controller 400 transmits a call service response message including the identifier of the mobile terminal 600 and the IP address of the mobile terminal 600 to the application server 500 in step S409.

When the mobile terminal 600 is in the idle state C300 in step 407, the paging controller 400 generates a paging request message, and transmits the paging request message to the at least one of the PARs 200 corresponding to the paging group including the mobile terminal 600 in step S411. In this case, the paging request message includes the MAC address of the mobile terminal 600, the identifier of the paging group including the mobile terminal 600, and the service-type information.

The PAR 200 receiving the paging request message transmits a paging notification message to the at least one AP 100 corresponding to the paging group including the mobile terminal 600 in step S413. The paging notification message includes the MAC address of the mobile terminal 600.

The AP 100 receiving the paging notification message provides the MAC address of the mobile terminal 600 to the MOB_PAG-ADV message that is defined in the IEEE 802.16(e) standard and corresponds to the paging message, and transmits the MOB_PAG-ADV message to the mobile terminal 600 in S415 so that the mobile terminal 600 may re-interface with the network in step S417.

The mobile terminal 600, determining that the MOB_PAG-ADV message includes the MAC address of the mobile terminal 600, re-interfaces with the wireless broadband network and the state of the mobile terminal 600 is changed to the normal operation state C200 in step S417. Since the mobile terminal 600 changes from the idle state C300 to the normal operation state C200, the PAR 200 performs the above location registration process to register the location of the mobile terminal 600 to the location server 300 in step S419.

The PAR 200 performing the location registration process establishes a provisioned DSA (Dynamic Service Addition) connection for the call service in step S421. In this case, provisioned connection establishment follows the IEEE 802.16(e) standard. The PAR 200 provides the mobile IP address to the mobile terminal 600, and establishes a connection for supporting a quality of service (QoS) according to a service-type in the paging request message.

The PAR 200 finishing the provisioned DSA establishment generates a paging response message in response to the paging request message to transmit it to the paging controller 400 in step S423. The paging response message includes the MAC and IP addresses of the mobile terminal 600, the IP address of the PAR 200 to which the mobile terminal 600 is accessed, and the identifier of the AP 100 to which the mobile terminal 600 is accessed.

The paging controller 400 receiving the paging response message generates the call service response message including the identifier and the IP address of the mobile terminal 600, and transmits it to the application server 500 in step S425.

The application server 500 obtaining the IP address of the mobile terminal 600 in steps S409 and S425 forwards the data for the mobile terminal 600 through the obtained IP address in step S427. That is, the application server 500 generates an IP packet including the IP address and the data for the mobile terminal 600, and transmits the IP packet to the mobile terminal 600.

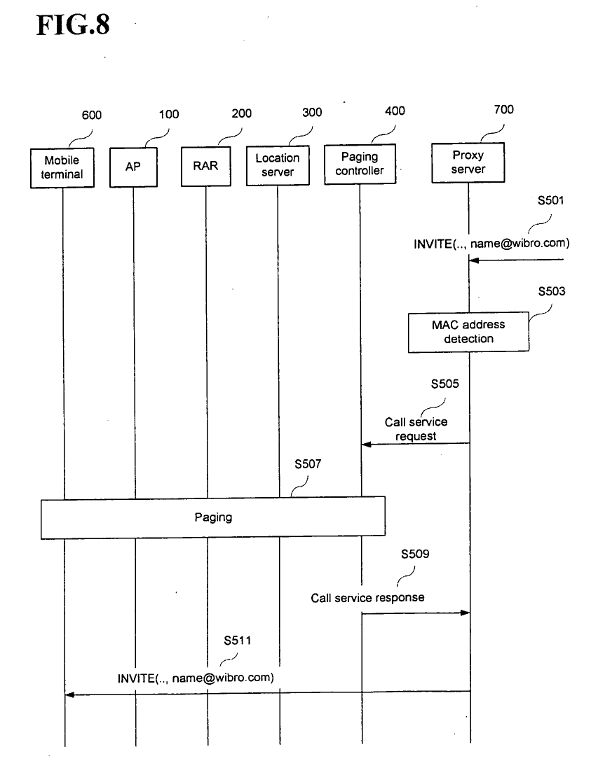

FIG. 8 shows a flowchart representing the VoIP service method according to the present invention.

In FIG. 8, a Session Initiation Protocol (SIP) proxy server 700 for the wireless broadband (hereinafter proxy server) corresponds to the application server 500 shown in FIG. 1.

When receiving an SIP invitation message INVITE for inviting the mobile terminal 600 corresponding to a NAI (e.g., name@wibro.com) in step S501, the proxy server 700 detects the MAC address corresponding to the NAI in step S503.

The proxy server 700 transmits the call service request message for the detected MAC address to the paging controller 400 in step S505. In this case, the call service request message includes the MAC address corresponding to the NAI and the SIP as a service type.

When the mobile terminal 400 is in the idle state, the paging controller 400 re-interfaces with the wireless broadband network in step S507, and it transmits the call service response message including the IP address, the location and the MAC address of the mobile terminal 600 to the proxy server 700 (S509).

The proxy server 700 transmits the SIP invitation message INVITE (name@wibro.com) to the mobile terminal 600 through the IP address in the received call service response message in step S511.

The above-described methods and apparatuses are not only realized by the preferred embodiments of the present invention, but are also intended to be realized by a program for realizing functions corresponding to the configuration of the preferred embodiments of the present invention or a recording medium for recording the program.

It is to be understood that the present invention is not limited to the disclosed embodiments, but is intended to cover various modifications and equivalent arrangements included within the spirit and scope of the appended claims.

What is claimed is:

1. A method for providing a call service for a mobile terminal to an application server in cooperation with a location server and a base station controller, the method comprising:
receiving, from the application server, a request for the call service for the mobile terminal;
detecting, from the location server, state information and location information of the mobile terminal;
transmitting, when the mobile terminal is in an idle state, a paging request message to the base station controller so that the mobile terminal interfaces with a network and receives a network address;
receiving, from the base station controller, a paging response message including the network address; and
transmitting, to the application server, a call service response message including the network address.

2. The method of claim 1, wherein receiving the request for the call service further comprises receiving, from the application server, a call service request message including an identifier of the mobile terminal.

3. The method of claim 2, wherein detecting the state and location information further comprises:
detecting a physical address of the mobile terminal that corresponds to the identifier of the mobile terminal; and
detecting the state and location information of the mobile terminal from the location server through the physical address.

4. The method of claim 2, wherein detecting the state and location information further comprises detecting the state and location information of the mobile terminal from the location server through the identifier of the mobile terminal.

5. The method of claim 1, wherein receiving the call service further comprises receiving, from the application server, a call service request message including a physical address of the mobile terminal, and detecting the state and location information comprises detecting the state and location information of the mobile terminal from the location server through a physical address of the mobile terminal.

6. The method of claim 2, wherein transmitting the paging request message further comprises:
determining a paging group including the mobile terminal from the location information of the mobile terminal; and
transmitting the paging request message to at least one base station controller corresponding to the paging group including the mobile terminal.

7. The method of claim 6, wherein transmitting the paging request message further comprises transmitting, to the base station controller, the paging request message including an identifier of the paging group that includes the mobile terminal, so that the base station transmits a paging notification message to at least one base station corresponding to the paging group of the mobile terminal.

8. The method of claim 2, wherein the call service request message further comprises service-type information, which is transmitted with the paging request message to the base station controller so that the base station controller establishes a connection for supporting a Quality of Service (QoS) according to the service-type information.

9. The method of claim 2, further comprising determining, when the mobile terminal is in a normal operation state, the network address of the mobile terminal from the location information of the mobile terminal to transmit the call service response message including the network address to the application server.

10. A method for paging a mobile terminal in cooperation with a base station, a paging controller and a location server, the method comprising:
receiving, from the paging controller, a paging request message having a physical address of the mobile terminal and an identifier of a paging group including the mobile terminal;
transmitting a paging notification message including the physical address of the mobile terminal to at least one base station corresponding to the identifier of the paging group so that the at least one base station transmits a paging message including the physical address of the mobile terminal to a channel link;
providing a network address to the mobile terminal when the mobile terminal interfaces with a network;
registering a location of the mobile terminal to the location server by network address and a location registration message including an identifier of an access point to which the mobile terminal is accessed; and
transmitting to the paging controller a paging response message including a physical address of the mobile terminal and the network address.

11. The method of claim 10, wherein the paging request message further comprises service-type information, and further comprises establishing a connection for supporting a Quality of Service (QoS) according to the service-type information when the mobile terminal interfaces with the network.

12. The method of claim 11, further comprising:
changing a state of the mobile terminal to an idle state when the mobile terminal in a normal operation state does not transmit/receive a packet for a predetermined time;
registering the location of the mobile terminal to the location server by the location registration message including the state of the mobile terminal and the identifier of the paging group that includes the mobile terminal.

13. The method of claim 12, further comprising:
changing the state of the mobile terminal to a power-off state when the mobile terminal in the idle state does not transmit/receive a packet for a predetermined time; and
transmitting the location registration message including the state of the mobile terminal to the location server so that the location server deletes location data for the mobile terminal.

14. The method of claim 13, further comprising registering, when the mobile terminal in the normal operation state performs handoff, the location of the mobile terminal to the location server by the location registration message having an address of the base station to which the mobile terminal is accessed.

15. A system for providing a call service for a mobile terminal to an application server, the system comprising:
a location server for managing a location of the mobile terminal in an idle state by an identifier of a paging group; and
a paging controller for detecting a state of the mobile terminal and the location of the mobile terminal from the location server when receiving the call service for the mobile terminal from the application server, requesting a paging operation from at least one paging controller corresponding to the paging group including the mobile terminal so that the mobile terminal receives a network address when the mobile terminal is in the idle state, and providing the network address to the application server.

16. The system of claim 15, wherein the location server manages the location of the mobile terminal in the idle state by a physical address, and the paging controller detects the state and the location of the mobile terminal by the physical address.

17. The system of claim 16, wherein the paging controller receives a request for the call service through the physical address.

18. The system of claim 16, wherein the paging controller detects the physical address corresponding to the network access identifier when receiving the request for the call service through a network access identifier, and detects the state and the location of the mobile terminal through the detected physical address.

19. The system of claim 15, wherein the location server manages the location of the mobile terminal in the idle state by a network access identifier, and the paging controller detects the state and the location of the mobile terminal by the network access identifier.

20. The system of claim 16, wherein the location server manages the location of the mobile terminal in a normal operation state by the physical address and the network address.

21. The system of claim 16, wherein the location server manages the location of the mobile terminal in a normal operation state by a network access identifier and the network address.
